(19) United States
(12) Patent Application Publication
(10) Pub. No.: US 2026/0210385 A1
(43) Pub. Date: Jul. 23, 2026

(54) Tolerance Compensation Fastening Assembly and Fastening System

(71) Applicant: Illinois Tool Works Inc., Glenview, IL (US)

(72) Inventors: Ruirui Wu, Shanghai (CN); Zhilin Li, Shanghai (CN); Jiahui He, Shanghai (CN)

(21) Appl. No.: 19/454,997

(22) Filed: Jan. 21, 2026

(30) Foreign Application Priority Data
Jan. 23, 2025 (CN) 202510108908.2
Jan. 16, 2026 (CN) 202610062975.X

(51) Int. Cl. F16B 5/02

(52) U.S. Cl. CPC F16B 5/025

(57) ABSTRACT

The present disclosure provides a tolerance compensation fastening assembly including an insert and a receiver. The insert has a shank portion with external threads and a flange provided at an end of the shank portion, and the flange is provided with a protrusion. The receiver has a body portion and a head portion, the body portion defines a passage with internal threads, the head portion includes an accommodation space in connection with the passage and a retaining wall defines at least a portion of the accommodation space. The retaining wall is provided with a limiting structure. The insert and the receiver are threadedly engaged via the shank portion and the passage, and the insert has a pre-assembled position relative to the receiver. When the insert is in the pre-assembled position, the flange is received in the accommodation space, and the protrusion engages with the limiting structure to restrict rotation of the insert relative to the receiver, thereby retaining the insert in the pre-assembled position. The tolerance compensation fastening assembly of the present disclosure can achieve retention of the insert in the pre-assembled position relative to the receiver with a simple and durable structure.

### RELATED APPLICATIONS

The present application claims the benefit of Chinese Patent Application Nos. 202510108908.2, filed Jan. 23, 2025, and 202610062975.X, filed Jan. 16, 2026, each titled “Tolerance Compensation Fastening Assembly and Fastening System,” the contents of which are hereby incorporated by reference.

### TECHNICAL FIELD

The present disclosure relates to a fastening assembly, and more specifically, to a tolerance compensation fastening assembly capable of compensating for tolerances and a fastening system.

### BACKGROUND

In various industrial applications, fastening assemblies can be used to connect components together. In some applications, there is a gap between the connected components, and part of the fastening assembly remains in this gap. Due to potential tolerances from manufacturing and installation, when the components are connected, the fastening assembly may rattle or slide within the gap, resulting in unwanted noise and providing a loose connection. A tolerance compensation fastening assembly can compensate for tolerances caused by manufacturing and installation while securing the two components.

Some tolerance compensation fastening assemblies include a receiver and an insert, which compensate for tolerances between components through the helical movement of the insert within the receiver.

### SUMMARY

The present disclosure relates generally to a tolerance compensation fastening assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a tolerance compensation fastening assembly according to an embodiment of the present disclosure from one perspective

FIG. 1B is a perspective view of the tolerance compensation fastening assembly shown in FIG. 1A from another perspective.

FIG. 1C is a front view of the tolerance compensation fastening assembly shown in FIG. 1A.

FIG. 1D is an exploded view of the tolerance compensation fastening assembly shown in FIG. 1A.

FIG. 2 is a top view of the tolerance compensation fastening assembly shown in FIG. 1A.

FIG. 3 is a cross-sectional view of the tolerance compensation fastening assembly shown in FIG. 1A.

FIG. 4A is a perspective view of an insert of the tolerance compensation fastening assembly shown in FIG. 1A from one perspective.

FIG. 4B is a perspective view of the insert of the tolerance compensation fastening assembly shown in FIG. 1A from another perspective.

FIG. 5A is a perspective view of a receiver of the tolerance compensation fastening assembly shown in FIG. 1A.

FIG. 5B is a top view of the receiver of the tolerance compensation fastening assembly shown in FIG. 1A.

FIG. 6A is a perspective view of a fastening system according to an embodiment of the present disclosure in a first state during an assembly process.

FIG. 6B is a front view of the fastening system shown in FIG. 6A in a second state during the assembly process.

FIG. 6C is a front view of the fastening system shown in FIG. 6A in a third state during the assembly process.

FIG. 6D is a front view of the fastening system shown in FIG. 6A in an assembled position.

FIG. 6E is a cross-sectional view of the fastening system shown in FIG. 6D.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first aspect of the present disclosure, the present disclosure provides a tolerance compensation fastening assembly including an insert and a receiver. The insert has a shank portion with external threads and a flange provided at an end of the shank portion, and the flange is provided with a protrusion. The receiver has a body portion and a head portion, the body portion defines a passage with internal threads, the head portion includes an accommodation space in connection with the passage and a retaining wall defines at least a portion of the accommodation space. The retaining wall is provided with a limiting structure. The insert and the receiver are threadedly engaged via the shank portion and the passage, and the insert has a pre-assembled position relative to the receiver. When the insert is in the pre-assembled position, the flange is received in the accommodation space, and the protrusion engages with the limiting structure to restrict rotation of the insert relative to the receiver, thereby retaining the insert in the pre-assembled position.

In some examples, the retaining wall is configured such that, when the protrusion and the limiting structure are engaged and a force applied to the insert in a first rotational direction exceeds a predetermined force, the retaining wall allows the limiting structure to separate from the protrusion through elastic deformation, thereby allowing the insert to rotate relative to the receiver in the first rotational direction away from the pre-assembled position. The first rotational direction is a direction in which the flange of the insert moves away from the receiver.

In some examples, the limiting structure includes a recess provided on an inner surface of the retaining wall and configured to accommodate the protrusion.

In some examples, the recess comprises a first limiting wall and a second limiting wall, and the protrusion comprises a first limited wall and a second limited wall. In the first rotational direction, the first limiting wall is on a downstream side of the recess, the second limiting wall is on an upstream side of the recess, the first limited wall is on a downstream side of the protrusion, and the second limited wall is on an upstream side of the protrusion. The first limiting wall cooperates with the first limited wall to provide a first blocking force restricting rotation of the insert in the first rotational direction, and the second limiting wall cooperates with the second limited wall to provide a second blocking force restricting rotation of the insert in a second rotational direction opposite to the first rotational direction. The first blocking force is the predetermined force. The first limited wall and the second limited wall have different inclination angles relative to a radial direction such that magnitudes of the first blocking force and the second blocking force are different.

In some examples, the inclination angle of the first limited wall relative to the radial direction is greater than that of the second limited wall relative to the radial direction, so that the second blocking force is greater than the first blocking force.

In some examples, the first limited wall and the second limited wall are arranged such that the protrusion forms a barb blocking rotation of the insert in the second rotational direction.

In some examples, the first limiting wall and the first limited wall are shaped to match each other and extend obliquely relative to the radial direction of the flange. The second limiting wall and the second limited wall are shaped to match each other and extend substantially along the radial direction of the flange.

In some examples, the protrusion and the recess are dimensioned such that when the protrusion is accommodated in the recess, the first limited wall and the second limited wall abut against the first limiting wall and the second limiting wall, respectively.

In some examples, the head portion further includes a base wall connected to the body portion. The retaining wall includes a first wall portion and a second wall portion, the first wall portion is connected to the base wall, the second wall portion is spaced from the base wall by an opening, and the recess is provided on an inner surface of the second wall portion.

In some examples, when the flange is received in the accommodation space, the first wall portion is spaced from an outer surface of the flange. The inner surface of the second wall portion protrudes inward relative to an inner surface of the first wall portion at least at a portion provided with the recess.

In some examples, the inner surface of the second wall portion includes a first connecting protrusion and a second connecting protrusion provided at an opening of the recess. In the first rotational direction, the first connecting protrusion is downstream of the second connecting protrusion. The first connecting protrusion connects the first limiting wall to the inner surface of the second wall portion downstream of the recess in the first rotational direction, and the second connecting protrusion connects the second limiting wall to the inner surface of the second wall portion upstream of the recess in the first rotational direction. The first connecting protrusion and the second connecting protrusion protrude further inward than other portions of the inner surface of the second wall portion.

In some examples, a portion of an outer surface of the second wall portion corresponding to the recess and the first connecting protrusion is recessed inward relative to other portions.

In some examples, a wall thickness of a portion of the second wall portion upstream of the second connecting protrusion in the first rotational direction is increased.

In some examples, the retaining wall is an annular wall.

In some examples, the receiver is integrally formed from a plastic material.

According to a second aspect of the present disclosure, the present disclosure provides a fastening system for connecting a first component to a second component. The fastening system includes the tolerance compensation fastening assembly according to the first aspect, a nut, and a bolt. The tolerance compensation fastening assembly is retained in the second component by the receiver. The bolt passes through the first component and the insert of the tolerance compensation fastening assembly and threadedly engages with the nut. The bolt engages with the insert and drives the insert to move relative to the receiver in the first rotational direction so that the flange of the insert abuts against the first component.

The aforementioned “first rotational direction” refers to the direction in which the flange of the insert moves away from the receiver.

The aforementioned “second rotational direction” refers to the direction in which the flange of the insert moves toward the receiver.

The tolerance compensation fastening assembly of the present disclosure, by providing the protrusion on the flange of the insert and the limiting structure on the retaining wall of the receiver, and through the engagement between the protrusion and the limiting structure, can achieve retention of the insert in the pre-assembled position relative to the receiver with a simple and durable structure.

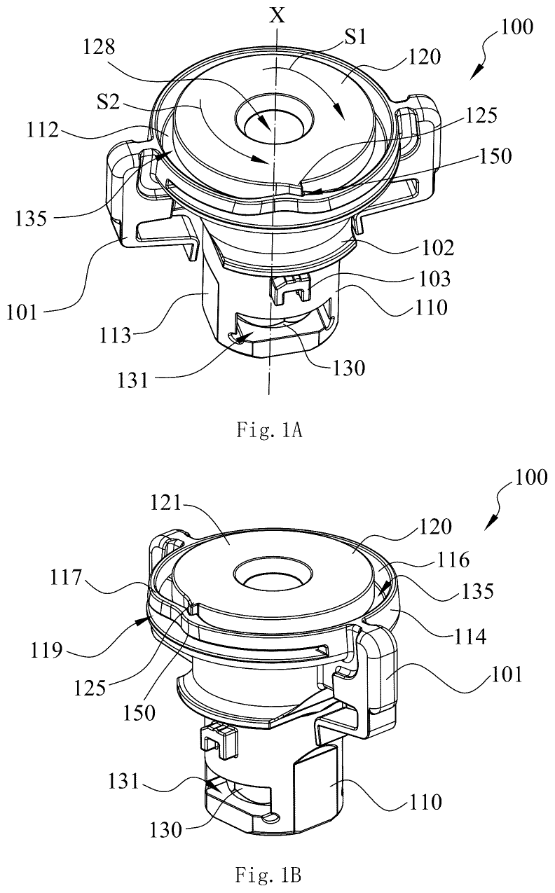

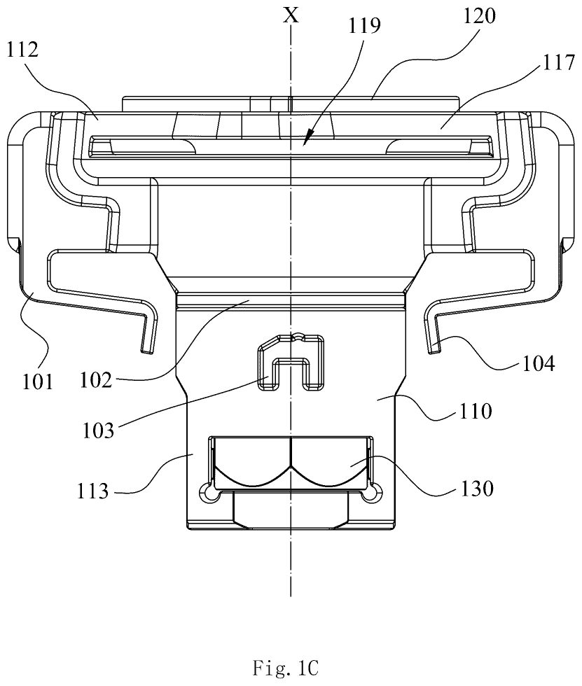

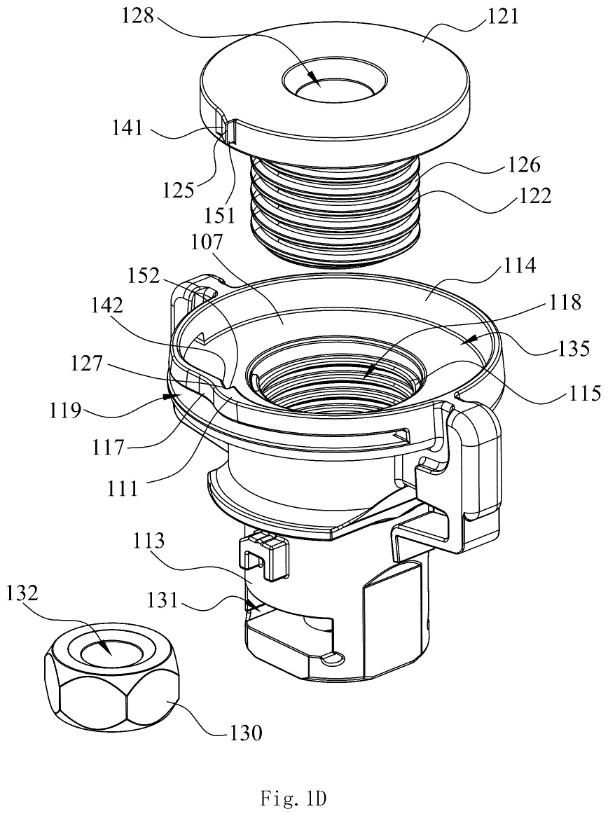

FIGS. 1A-1D illustrate the structure of a tolerance compensation fastening assembly 100 according to an embodiment of the present disclosure. FIGS. 1A and 1B show perspective structural views of the tolerance compensation fastening assembly 100 from two different perspectives, FIG. 1C shows a front view of the tolerance compensation fastening assembly 100, and FIG. 1D shows an exploded view of the tolerance compensation fastening assembly 100.

As shown in FIGS. 1A-1D, the tolerance compensation fastening assembly 100 includes a receiver 110 and an insert 120, and has a central axis X. The receiver 110 includes a head portion 112 and a body portion 113, with the head portion 112 provided at an end of the body portion 113. The body portion 113 defines a passage 118, and the head portion 112 includes an accommodation space 135 in connection with the passage 118. The insert 120 includes a flange 121 and a shank portion 122, with the flange 121 provided at an end of the shank portion 122. The shank portion 122 of the insert 120 can be received within the passage 118 of the receiver 110. The shank portion 122 of the insert 120 has external threads 126, and the inner wall of the passage 118 correspondingly has internal threads 115. The insert 120 and the receiver 110 are threadedly engaged via the external threads 126 of the shank portion 122 and the internal threads 115 of the passage 118. Therefore, the insert 120 can perform a helical movement within the passage 118, for example, spiraling upwards along a first rotational direction S1 to move the flange 121 of the insert 120 away from the receiver 110, or spiraling downwards along a second rotational direction S2 opposite to the first rotational direction S1. The receiver 110 is integrally formed from a plastic material, and the insert 120 may also be integrally formed from a plastic material.

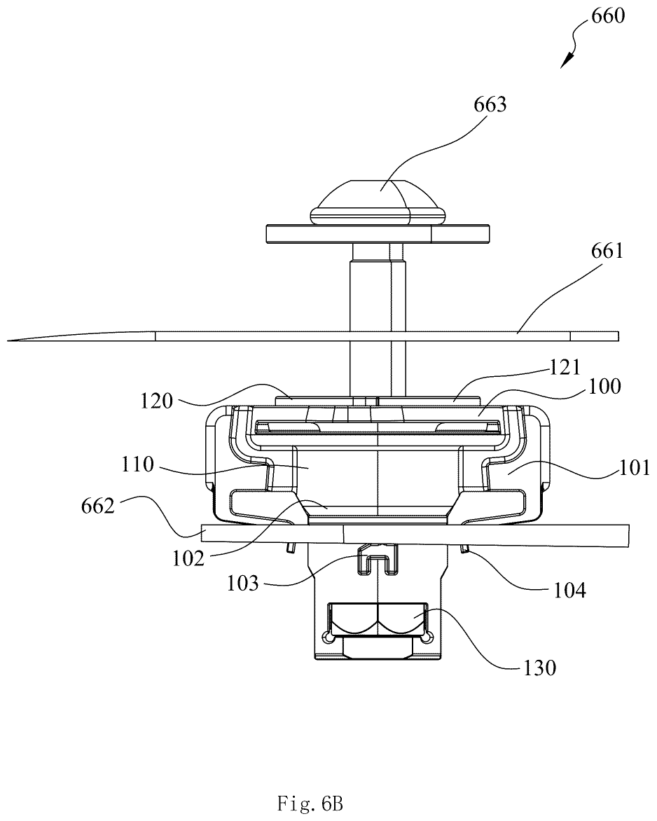

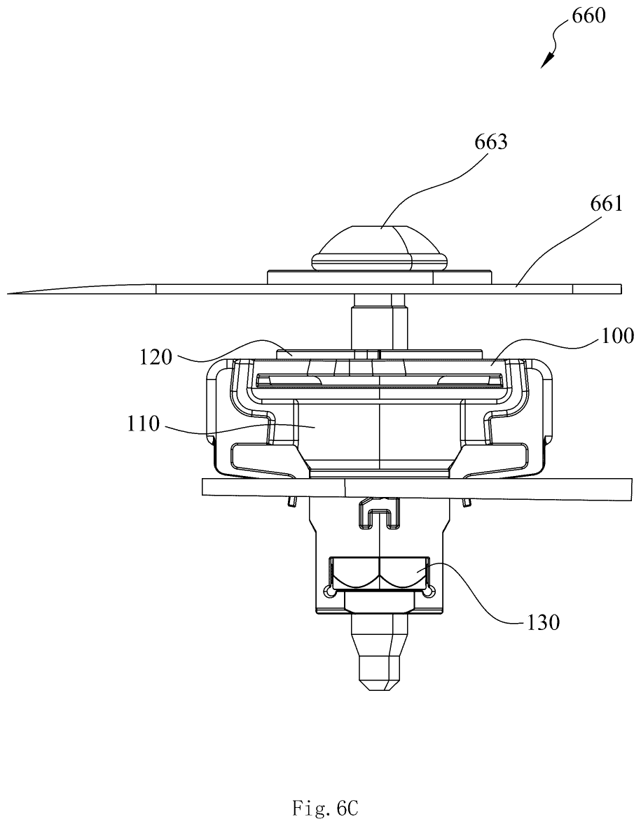

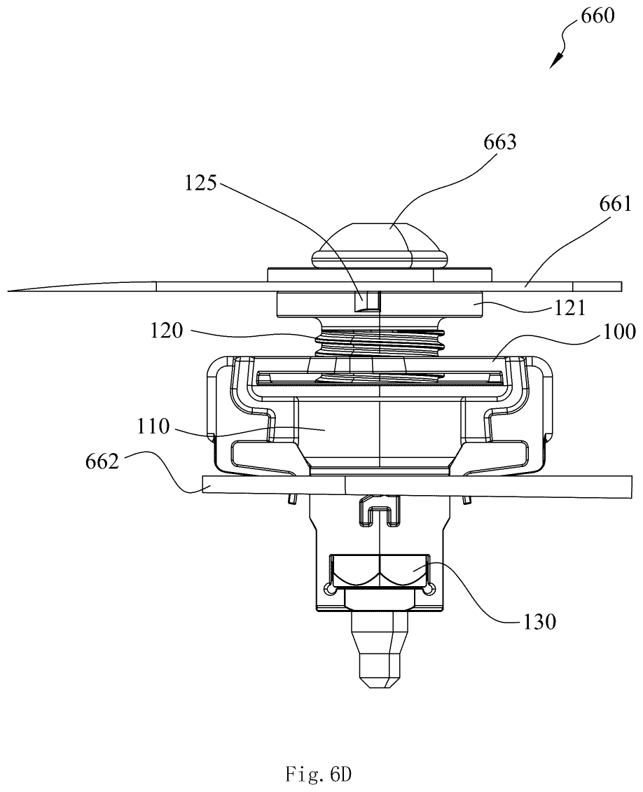

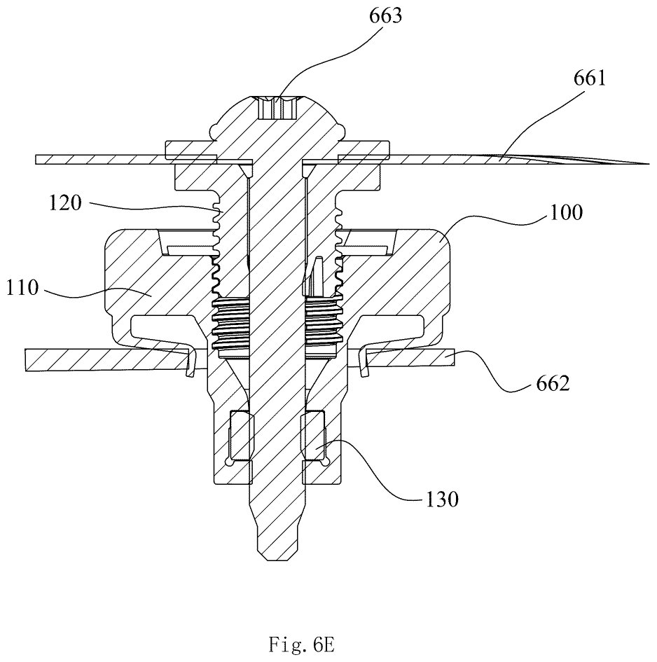

The insert 120 has an inner passage 128 axially extending therethrough. The inner passage 128 is used for engaging with a bolt 663 (as shown in FIGS. 6B and 6C) to provide a driving force via the bolt 663 for driving the helical movement of the insert 120. Thus, the tolerance compensation fastening assembly 100 can increase its axial length through the helical movement of the insert 120 to compensate for tolerances between a first component 661 and a second component 662 (see FIGS. 6A-6E).

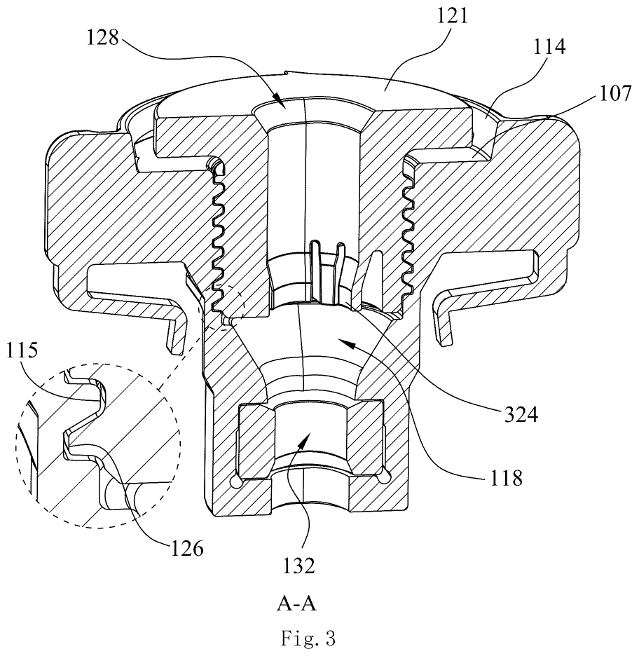

The body portion 113 of the receiver 110 is substantially a hollow cylinder shape, and the passage 118 extends axially through the body portion 113. The upper portion of the passage 118 is used for threaded connection with the shank portion 122 of the insert 120, and the lower portion of the passage 118 is used to accommodate the bolt 663 (as shown in FIGS. 6B and 6C). In the illustrated example, the inner wall of the upper portion of the passage 118 is provided with internal threads 115, and the inner diameter of the upper portion of the passage 118 is larger than that of the lower portion. The inner diameter of the lower portion of the passage 118 is substantially the same as the inner diameter of the inner passage 128 of the shank portion 122 of the insert 120, both matching the outer diameter of the bolt 663 (see FIG. 3).

The head portion 112 includes a base wall 107 and a retaining wall 114. The base wall 107 is a plate shape extending laterally from the top edge of the body portion 113. In the illustrated example, the retaining wall 114 is an annular wall connected above the circumferential edge of the base wall 107 and surrounding the base wall 107. The base wall 107 and the retaining wall 114 together form the accommodation space 135. The retaining wall 114 includes a first wall portion 116 and a second wall portion 117. The first wall portion 116 is connected to the base wall 107, and the second wall portion 117 is spaced from the base wall 107 by an opening 119. Through this structure, the retaining wall 114 can have greater elasticity at the second wall portion 117, making it easier to elastically deform inward or outward. In some examples, the retaining wall 114 may not be annular, as long as it at least partially defines the accommodation space 135 for accommodating the flange 121. Furthermore, in some examples, the second wall portion 117 may not be spaced from the base wall 107, as long as its size and shape are configured to be prone to elastic deformation.

The outer wall of the receiver 110 is configured to have a shape and structure matching the second component 662 (see FIG. 6A), so that the receiver 110 can be connected to the second component 662, for example, via a snap-fit connection. In the illustrated example, the outer surface of the receiver 110 is provided with a pair of engaging arms 101, which are configured to snap into a mounting hole 665 of the second component 662 (see FIG. 6A). Each engaging arm 101 is configured to extend outward from the receiver 110 in a bent shape. The free end of each engaging arm 101 forms a bent tab 104 extending axially. The bent tab 104 is used to abut against the wall of the mounting hole 665 of the second component 662 to retain the body portion 113 within the second component 662 and prevent radial movement of the receiver 110 relative to the second component 662. As shown in FIG. 6A, the mounting hole 665 is configured to have a shape with squared end portions to prevent the receiver 110 from rotating within the mounting hole 665 of the second component 662. The outer surface of the body portion 113 is also provided with at least one upper protrusion 102 and at least one lower protrusion 103. When the receiver 110 is connected within the second component 662, the upper protrusion 102 and the lower protrusion 103 clamp the second component 662 therebetween. Thus, after the receiver 110 is connected to the second component 662, the receiver 110 cannot rotate or move relative to the second component 662. Those skilled in the art will understand that the outer wall of the receiver 110 can be configured in any structure, as long as it matches the mounting hole 665 of the second component 662, allowing the receiver 110 to be connected to the second component 662.

The tolerance compensation fastening assembly 100 further includes a nut 130 disposed within the receiver 110. In the illustrated example, the bottom of the body portion 113 of the receiver 110 is provided with a nut mounting groove 131 extending radially, and the nut 130 is accommodated within the nut mounting groove 131. The nut mounting groove 131 can restrict movement of the nut 130. The nut 130 has a nut passage 132. The nut passage 132 is in connection with the inner passage 128 of the insert 120 to receive the bolt 663. The bolt 663 is fastened to the tolerance compensation fastening assembly 100 via the nut 130.

The insert 120 has a pre-assembled position relative to the receiver 110 as shown in FIGS. 1A-1D. The flange 121 of the insert 120 is provided with a protrusion 125, and the retaining wall 114 of the receiver 110 is provided with a limiting structure 150. When the insert 120 is in the pre-assembled position, the flange 121 is received in the accommodation space 135 of the receiver 110, and the protrusion 125 engages with the limiting structure 150 to restrict rotation of the insert 120 relative to the receiver 110, thereby retaining the insert 120 in the pre-assembled position. In the illustrated example, the limiting structure 150 includes a recess 127. The recess 127 is provided on the inner surface of the second wall portion 117 of the retaining wall 114 and is used to accommodate the protrusion 125. Through the structural cooperation between the protrusion 125 and the recess 127, rotation of the insert 120 relative to the receiver 110 can be restricted. When the protrusion 125 is engaged with the limiting structure 150, if a force applied to the insert 120 in the first rotational direction S1 exceeds a predetermined force, the retaining wall 114 allows separation of the limiting structure 150 from the protrusion 125 via elastic deformation, thereby allowing the insert 120 to rotate relative to the receiver 110 in the first rotational direction S1 away from the pre-assembled position. In the illustrated example, the retaining wall 114 allows the protrusion 125 to exit the recess 127 via elastic deformation at the second wall portion 117.

Thus, when the insert 120 is in the pre-assembled position, the relative positions between the insert 120 and the receiver 110 can remain stable, making the tolerance compensation fastening assembly 100 suitable for vibratory environments such as during transportation, preventing the insert 120 from leaving the pre-assembled position and potentially detaching. Additionally, the above configuration can also prevent the insert 120 and the receiver 110 from seizing due to over-tightening when the fastening assembly is being disassembled. However, the above configuration allows the insert 120 to move relative to the receiver 110 when the insert 120 is subjected to a driving force, such as applied by the bolt 663, that is greater than the predetermined force, in order to compensate for the tolerances between the first component 661 and the second component 662 (see FIGS. 6A-6E).

Those skilled in the art will understand that, in some examples, the portion that elastically deforms could also be provided on the insert 120. For example, the protrusion could be configured as a cantilever shape, etc., allowing the insert 120 to leave the pre-assembled position via elastic deformation of the insert 120 itself.

The recess 127 includes a first limiting wall 142 and a second limiting wall 152. The protrusion 125 includes a first limited wall 141 and a second limited wall 151. In the first rotational direction S1, the first limiting wall 142 is on the downstream side of the recess 127, and the second limiting wall 152 is on the upstream side of the recess 127. The first limited wall 141 is on the downstream side of the protrusion 125, and the second limited wall 151 is on the upstream side of the protrusion 125. The first limiting wall 142 and the first limited wall 141 cooperate with each other, and the second limiting wall 152 and the second limited wall 151 cooperate with each other. More specific cooperation structure of the protrusion 125 and the recess 127 will be described in detail later.

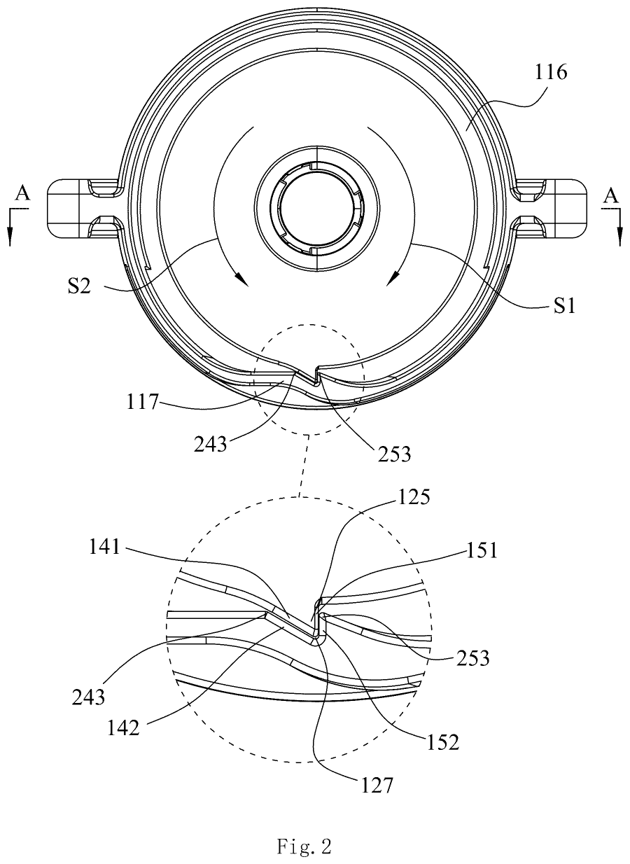

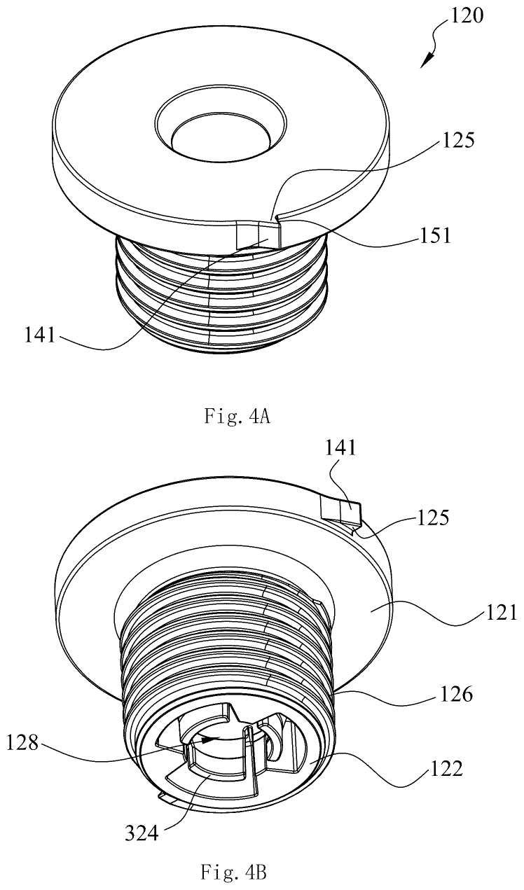

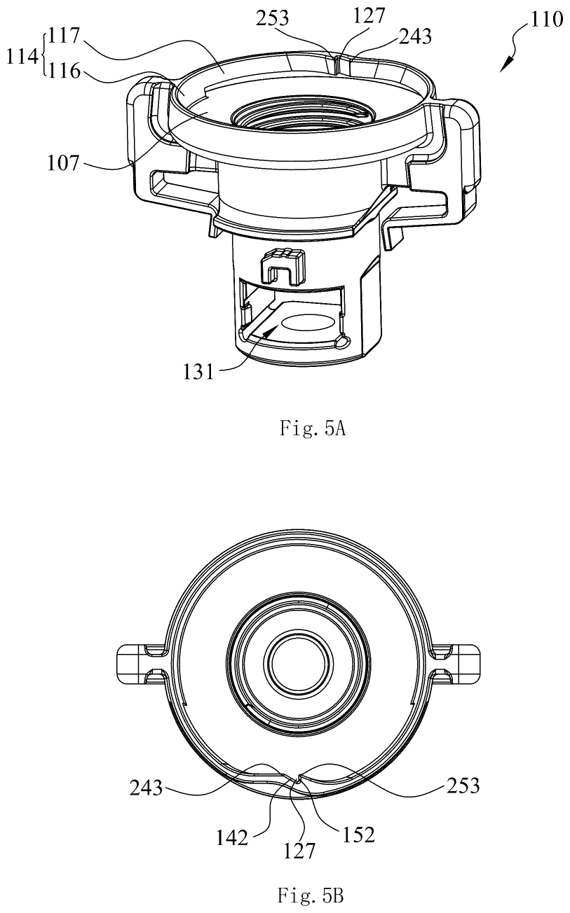

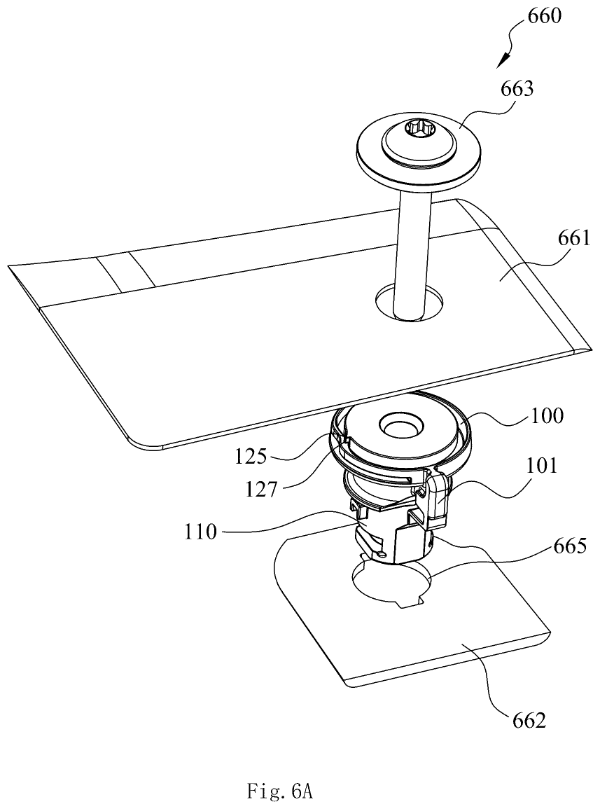

FIG. 2 shows a top view of the tolerance compensation fastening assembly 100 shown in FIG. 1A, illustrating the structure of the protrusion 125 and the recess 127 in detail. FIGS. 4A and 4B show the more specific structure of the insert 120. FIGS. 5A and 5B show the more specific structure of the receiver 110.

As shown in FIGS. 2, 1A-1D, 4A-4B, and 5A-5B, when the flange 121 of the insert 120 is received in the accommodation space 135 of the receiver 110, the first wall portion 116 of the retaining wall 114 is spaced from the outer surface of the flange 121, so that the rotation of the protrusion 125 within the accommodation space 135 is not blocked by structures other than the limiting structure 150. The inner surface of the second wall portion 117 of the retaining wall 114 protrudes inward relative to the inner surface of the first wall portion 116 at least at the portion provided with the recess 127, so that the retaining wall 114 can engage with the protrusion 125 at the recess 127. The protrusion 125 and the recess 127 are dimensioned such that when the protrusion 125 is accommodated in the recess 127, the first limited wall 141 and the second limited wall 151 of the protrusion 125 respectively abut against the first limiting wall 142 and the second limiting wall 152 of the recess 127.

The first limiting wall 142 of the recess 127 and the first limited wall 141 of the protrusion 125 cooperate to provide a first blocking force that restricts rotation of the insert 120 in the first rotational direction S1. The first blocking force is the predetermined force. That is, when a force applied to the insert 120 in the first rotational direction S1 is greater than the first blocking force, the insert 120 can leave the pre-assembled position, whereas when the applied force is not greater than the first blocking force, the recess 127 can retain the protrusion 125 in place, restricting rotation of the insert 120 in the first rotational direction S1.

The second limiting wall 152 and the second limited wall 151 cooperate to provide a second blocking force that restricts rotation of the insert 120 in the second rotational direction S2. That is, when a force applied to the insert 120 in the second rotational direction S2 is not greater than the second blocking force, the recess 127 can retain the protrusion 125 in place, blocking rotation of the insert 120 in the second rotational direction S2. By configuring the cooperating shapes of the recess 127 and the protrusion 125, the second blocking force can be made much greater than the first blocking force. Thus, an operator can rotate the insert 120 in the first rotational direction S1 during assembly to achieve tolerance compensation but finds it difficult to rotate the insert 120 in the second rotational direction S2.

In the illustrated example, the first limited wall 141 and the second limited wall 151 are configured such that the protrusion 125 forms a barb shape that blocks rotation of the insert 120 in the second rotational direction S2. That is, by configuring the protrusion 125 as a barb shape and correspondingly configuring the shape of the recess 127, the receiver 110 can block the insert 120 from rotating in the second rotational direction S2, but when the insert 120 is subjected to a force greater than the first blocking force, it allows the insert 120 to rotate in the first direction S1. In the illustrated example, the first limiting wall 142 and the first limited wall 141 extend obliquely relative to the radial direction of the flange 121, meaning their angle of inclination relative to the radial direction is not 0°. The second limiting wall 152 and the second limited wall 151 extend substantially along the radial direction of the flange 121, meaning their angle of inclination relative to the radial direction is substantially 0°. In some examples, the first limiting wall 142, the first limited wall 141, the second limiting wall 152, and the second limited wall 151 are all flat straight walls. Those skilled in the art will understand that, in some examples, the protrusion and the recess may not have the shapes shown, as long as the first limited wall 141 and the second limited wall 151 are configured to have different angles of inclination relative to the radial direction, and the first limiting wall 142 and the second limiting wall 152 are configured accordingly, so that the magnitudes of the first blocking force and the second blocking force are different. In some examples, having the inclination angle of the first limited wall 141 relative to the radial direction be greater than that of the second limited wall 151 relative to the radial direction can make the second blocking force greater than the first blocking force.

The inner surface of the second wall portion 117 of the retaining wall 114 includes a first connecting protrusion 243 and a second connecting protrusion 253 at the opening of the recess 127. In the first rotational direction S1, the first connecting protrusion 243 is downstream of the second connecting protrusion 253. The first connecting protrusion 243 connects the first limiting wall 142 to the inner surface of the second wall portion 117 downstream of the recess 127 in the first rotational direction S1. The second connecting protrusion 253 connects the second limiting wall 152 to the inner surface of the second wall portion 117 upstream of the recess 127 in the first rotational direction S1. The first connecting protrusion 243 facilitates the protrusion 125 applying a pressing force on the second wall portion 117, causing the second wall portion 117 to elastically deform outward.

In the illustrated example, the portion of the outer surface of the second wall portion 117 corresponding to the recess 127 and the first connecting protrusion 243 is recessed inward relative to other portions. In other words, the second wall portion 117 is substantially inwardly bent at the recess 127 and the first connecting protrusion 243. This bent shape helps prevent the wall thickness at the recess 127 and the first connecting protrusion 243 from being increased and weakens the strength at the first connecting protrusion 243 of the second wall portion 117, increasing its elasticity, which is more conducive to elastic deformation.

Thus, when the insert 120 rotates in the second rotational direction S2 to the pre-assembled position, the protrusion 125, by pressing on the first connecting protrusion 243, causes the second wall portion 117 to elastically deform outward, allowing the protrusion 125 to enter the recess 127. When the insert 120 rotates from the pre-assembled position in the first rotational direction S1, the protrusion 125 can also, by pressing on the first connecting protrusion 243, cause the second wall portion 117 to elastically deform outward, allowing the protrusion 125 to exit the recess 127.

The wall thickness of the portion of the second wall portion 117 upstream of the second connecting protrusion 253 in the first rotational direction S1 is increased, so that the strength at the second connecting protrusion 253 is increased, and the elasticity of the second wall portion 117 at the second connecting protrusion 253 can be reduced. This is more conducive to the second limiting wall 152 blocking movement of the protrusion 125 in the second rotational direction S2.

FIG. 3 further illustrates the internal structure of the tolerance compensation fastening assembly 100 in detail. As shown in FIG. 3, the insert 120 includes at least one engaging claw 324. The engaging claw 324 is provided on the inner wall defining the inner passage 128 of the insert 120. The engaging claw 324 is used to engage with the bolt 663 so that rotation of the bolt 663 drives rotation of the insert 120, causing the insert 120 to spiral up or down relative to the receiver 110. In this example, the engaging claw 324 is configured as a cantilever shape protruding inward into the inner passage 128 from top to bottom. The bottom of the engaging claw 324 can contact the bolt 663 and apply a certain degree of clamping force, so that when the bolt 663 rotates, the friction between the engaging claw 324 and the bolt 663 drives the rotation of the insert 120. When the insert 120 can no longer rise (e.g., when it abuts the lower surface of the first component 661), the engaging claw 324 does not hinder the rotation of the bolt 663. Those skilled in the art will understand that the engaging claw 324 of the insert 120 can be configured in any shape, or other cooperating structures can be used instead of the engaging claw 324, as long as it can cooperate with the bolt 663 so that rotation of the bolt 663 can drive rotation of the insert 120.

Still referring to FIG. 3, to facilitate the bolt 663 driving the rotation of the insert 120, the external threads 126 of the insert 120 and the internal threads 115 of the receiver 110 are in a loosely engaged state. That is, when the insert 120 is connected to the receiver 110, there is a small gap between the external threads 126 and the internal threads 115. Furthermore, there is also a gap between the lower surface of the flange 121 of the insert 120 and the base wall 107 of the receiver 110. Therefore, if the protrusion 125 and the limiting structure 150 were not provided, even though the insert 120 is threadedly connected to the receiver 110 in the pre-assembled position, under external vibration, the insert 120 might still undergo undesired rotation relative to the receiver 110. If the insert 120 rotates relative to the receiver 110 in the first rotational direction S1, it might lead to the insert 120 detaching from the receiver 110. If the insert 120 rotates relative to the receiver 110 in the second rotational direction S2, it might cause the insert 120 and the receiver 110 to seize, preventing the driving of the insert 120 relative to the receiver 110 by turning the bolt 663.

FIGS. 6A-6E illustrate the specific structure of a fastening system 660 including the tolerance compensation fastening assembly 100. FIG. 6A is a perspective view of the fastening system 660 in a first state during the assembly process, FIG. 6B is a perspective view of the fastening system 660 in a second state during the assembly process, FIG. 6C is a perspective view of the fastening system 660 in a third state during the assembly process, and FIGS. 6D and 6E are views of the fastening system 660 in an assembled position.

As shown in FIG. 6A, the fastening system 660 includes the first component 661, the second component 662, the bolt 663, and the tolerance compensation fastening assembly 100. The second component 662 is provided with the mounting hole 665. In some examples, the first component 661 and the second component 662 are in a fixed state, e.g., both fixed relative to a vehicle.

When the fastening system 660 is in the first state during assembly as shown in FIG. 6A, the insert 120 of the tolerance compensation fastening assembly 100 is in the pre-assembled position. The tolerance compensation fastening assembly 100 is inserted into the gap between the first component 661 and the second component 662, and the engaging arms 101 of the receiver 110 are aligned with the mounting hole 665 of the second component 662. The bolt 663 passes from above the first component 661 through the first component 661 and into the inner passage 128 of the insert 120 of the tolerance compensation fastening assembly 100 until reaching the state shown in FIG. 6B.

As shown in FIG. 6B, when the fastening system 660 is in the second state during assembly, the receiver 110 of the tolerance compensation fastening assembly 100 is snapped into the mounting hole 665 of the second component 662. The engaging arms 101 of the receiver 110 abut the edge of the mounting hole 665, and the upper protrusion 102 and lower protrusion 103 of the receiver 110 clamp the second component 662. Thus, the receiver 110 is connected to the second component 662. The first component 661 is located above the tolerance compensation fastening assembly 100. The insert 120 of the tolerance compensation fastening assembly 100 is still in the pre-assembled position. There is a gap between the upper surface of the flange 121 of the insert 120 and the lower surface of the first component 661. The bolt 663 passes through the inner passage 128 of the insert 120 and begins to be received by the nut passage 132 of the nut 130 of the tolerance compensation fastening assembly 100. In this state, if an operator turns the bolt 663, the bolt 663 can be fastened to the nut 130, causing the bolt 663 to descend relative to the first component 661 to the state shown in FIG. 6C.

As shown in FIG. 6C, when the fastening system 660 is in the third state during assembly, the bolt 663 abuts the upper surface of the first component 661 and can descend no further. However, the bolt 663 can still rotate and apply a driving force in the first rotational direction S1 to the insert 120. Since this driving force is greater than the first blocking force, the second wall portion 117 of the receiver 110 elastically deforms at the first connecting protrusion 243, allowing the protrusion 125 to separate from the recess 127, thereby allowing the insert 120 to leave the pre-assembled position and perform a helical upward movement until reaching the state shown in FIGS. 6D and 6E.

As shown in FIGS. 6D and 6E, when the fastening system 660 is in the assembled position, the upper surface of the flange 121 of the insert 120 abuts the lower surface of the first component 661, enabling the fastening system 660 to compensate for tolerances between the first component 661 and the second component 662. The first component 661 is clamped between the bolt 663 and the flange 121 of the insert 120 of the tolerance compensation fastening assembly 100. The second component 662 is snapped to the receiver 110 of the tolerance compensation fastening assembly 100. Therefore, the positions of the first component 661, the tolerance compensation fastening assembly 100, and the second component 662 are relatively fixed. Even if the tolerances between the first component 661 and the second component 662 may be large, the tolerance compensation fastening assembly 100 will not rattle within the gap between the first and second components. Thus, the tolerance compensation fastening assembly 100 can compensate for the tolerances between the first component 661 and the second component 662, ensuring a firm connection between them.

During disassembly, an operator applies a driving force in the second rotational direction S2 to the insert 120 of the tolerance compensation fastening assembly 100 by turning the bolt 663 in reverse, driving the insert 120 to perform a helical downward movement relative to the receiver 110. This moves the fastening system 660 from the state shown in FIGS. 6D and 6E to the state shown in FIG. 6C. During this process, the protrusion 125 of the insert 120 of the tolerance compensation fastening assembly 100 presses against the first connecting protrusion 243 on the second wall portion 117 of the receiver 110, causing elastic deformation of the second wall portion 117 at the first connecting protrusion 243 and allowing the protrusion 125 to enter the recess 127. Subsequently, the insert 120 stops its downward helical movement and reaches the pre-assembled position.

The operator then continues to turn the bolt 663, returning the fastening system 660 to the state shown in FIG. 6B. In the state shown in FIG. 6B, the operator can remove the bolt 663. Furthermore, by pressing the bent tabs 104 of the engaging arms 101 of the receiver 110, the operator can detach the receiver 110 of the tolerance compensation fastening assembly 100 from the second component 662, thereby separating the tolerance compensation fastening assembly 100 from the first and second components 661, 662.

In some extreme environments or under conditions like corrosion and contamination, the relative positions or thicknesses of the first component 661 and second component 662 may change. The tolerance compensation fastening assembly 100 can also ensure the reliability of the connection between the first component 661 and the second component 662, thereby extending the service life of these components.

Furthermore, the tolerance compensation fastening assembly 100 can flexibly compensate for tolerances between the first component 661 and the second component 662 within a certain range. When multiple tolerance compensation fastening assemblies 100 are used to connect the first component 661 and the second component 662, the flexible tolerance compensation enables the components to achieve a smoother and more aesthetically pleasing external appearance.

In some specific applications, the first component 661 is a vehicle body panel, and the second component 662 is a vehicle light, such as a headlamp.

The tolerance compensation fastening assembly of the present disclosure, by providing the protrusion on the flange of the insert and the limiting structure on the retaining wall of the receiver, and through the engagement between the protrusion and the limiting structure, can achieve retention of the insert in the pre-assembled position relative to the receiver with a simple and durable structure.

While the present disclosure has been described in conjunction with the examples of embodiments outlined above, various alternatives, modifications, variations, improvements and/or substantial equivalents, whether known or that are or may be presently foreseen, may become apparent to those having at least ordinary skill in the art. The technical effects and technical problems in the specification are exemplary and are not limiting. It should be noted that the embodiments described in the specification may have other technical effects and can solve other technical problems. Accordingly, the examples of embodiments of the present disclosure, as set forth above, are intended to be illustrative, not limiting. Various changes may be made without departing from the spirit or scope of the invention. Therefore, the present disclosure is intended to embrace all known or earlier developed alternatives, modifications, variations, improvements and/or substantial equivalents.

### Main Reference Signs

100 Tolerance compensation fastening assembly
101 Engaging arm
102 Upper protrusion
103 Lower protrusion
107 Base wall
110 Receiver
112 Head portion
113 Body portion
114 Retaining wall
115 Internal threads
116 First wall portion
117 Second wall portion
118 Passage
119 Opening
120 Insert
121 Flange
122 Shank portion
125 Protrusion
126 External threads
127 Recess
128 Inner passage
130 Nut
131 Nut mounting groove
132 Nut passage
135 Accommodation space
141 First limited wall
142 First limiting wall
150 Limiting structure
151 Second limited wall
152 Second limiting wall
243 First connecting protrusion
253 Second connecting protrusion
324 Engaging claw
660 Fastening system
661 First component
662 Second component
663 Bolt
665 Mounting hole

What is claimed is:

1. A tolerance compensation fastening assembly, comprising:
an insert having a shank portion with external threads and a flange provided at an end of the shank portion, the flange being provided with a protrusion; and
a receiver having a body portion and a head portion, the body portion defining a passage with internal threads, the head portion comprising an accommodation space in connection with the passage and a retaining wall defining at least a portion of the accommodation space, the retaining wall being provided with a limiting structure,
wherein the insert and the receiver are threadedly engaged via the shank portion and the passage, and the insert has a pre-assembled position relative to the receiver; and
wherein when the insert is in the pre-assembled position, the flange is received in the accommodation space, and the protrusion engages with the limiting structure to restrict rotation of the insert relative to the receiver, thereby retaining the insert in the pre-assembled position.

2. The tolerance compensation fastening assembly according to claim 1, wherein the retaining wall is configured such that, when the protrusion and the limiting structure are engaged and a force applied to the insert in a first rotational direction exceeds a predetermined force, the retaining wall allows the limiting structure to separate from the protrusion through elastic deformation, thereby allowing the insert to rotate relative to the receiver in the first rotational direction away from the pre-assembled position, wherein the first rotational direction is a direction in which the flange of the insert moves away from the receiver.

3. The tolerance compensation fastening assembly according to claim 2, wherein the limiting structure comprises a recess provided on an inner surface of the retaining wall and configured to accommodate the protrusion.

4. The tolerance compensation fastening assembly according to claim 3, wherein the recess comprises a first limiting wall and a second limiting wall, and the protrusion comprises a first limited wall and a second limited wall, wherein, in the first rotational direction, the first limiting wall is on a downstream side of the recess, the second limiting wall is on an upstream side of the recess, and the first limited wall is on a downstream side of the protrusion, the second limited wall is on an upstream side of the protrusion;
wherein the first limiting wall cooperates with the first limited wall to provide a first blocking force restricting rotation of the insert in the first rotational direction, and the second limiting wall cooperates with the second limited wall to provide a second blocking force restricting rotation of the insert in a second rotational direction opposite to the first rotational direction, the first blocking force being the predetermined force;
wherein the first limited wall and the second limited wall have different inclination angles relative to a radial direction such that magnitudes of the first blocking force and the second blocking force are different.

5. The tolerance compensation fastening assembly according to claim 4, wherein the inclination angle of the first limited wall relative to the radial direction is greater than that of the second limited wall relative to the radial direction, so that the second blocking force is greater than the first blocking force.

6. The tolerance compensation fastening assembly according to claim 5, wherein the first limited wall and the second limited wall are arranged such that the protrusion forms a barb blocking rotation of the insert in the second rotational direction.

7. The tolerance compensation fastening assembly according to claim 6, wherein the first limiting wall and the first limited wall are shaped to match each other and extend obliquely relative to the radial direction of the flange; and
wherein the second limiting wall and the second limited wall are shaped to match each other and extend substantially along the radial direction of the flange.

8. The tolerance compensation fastening assembly according to claim 4, wherein the protrusion and the recess are dimensioned such that when the protrusion is accommodated in the recess, the first limited wall and the second limited wall abut against the first limiting wall and the second limiting wall, respectively.

9. The tolerance compensation fastening assembly according to claim 4, wherein the head portion further comprises a base wall connected to the body portion; and
wherein the retaining wall comprises a first wall portion and a second wall portion, the first wall portion being connected to the base wall, the second wall portion being spaced apart from the base wall by an opening, and the recess being provided on an inner surface of the second wall portion.

10. The tolerance compensation fastening assembly according to claim 9, wherein when the flange is received in the accommodation space, the first wall portion is spaced apart from an outer surface of the flange; and
wherein the inner surface of the second wall portion protrudes inward relative to an inner surface of the first wall portion at least at the portion provided with the recess.

11. The tolerance compensation fastening assembly according to claim 10, wherein the inner surface of the second wall portion comprises a first connecting protrusion and a second connecting protrusion provided at an opening of the recess;
wherein in the first rotational direction, the first connecting protrusion is downstream of the second connecting protrusion;
wherein the first connecting protrusion connects the first limiting wall to the inner surface of the second wall portion downstream of the recess in the first rotational direction, and the second connecting protrusion connects the second limiting wall to the inner surface of the second wall portion upstream of the recess in the first rotational direction; and
wherein the first connecting protrusion and the second connecting protrusion protrude further inward than other portions of the inner surface of the second wall portion.

12. The tolerance compensation fastening assembly according to claim 11, wherein a portion of an outer surface of the second wall portion corresponding to the recess and the first connecting protrusion is recessed inward relative to other portions.

13. The tolerance compensation fastening assembly according to claim 11, wherein a wall thickness of a portion of the second wall portion upstream of the second connecting protrusion in the first rotational direction is increased.

14. The tolerance compensation fastening assembly according to claim 1, wherein the retaining wall is an annular wall.

15. The tolerance compensation fastening assembly according to claim 1, wherein the receiver is integrally formed from a plastic material.

16. A fastening system for connecting a first component to a second component, comprising:
the tolerance compensation fastening assembly according to claim 1, the tolerance compensation fastening assembly being retained in the second component by the receiver;
a nut; and
a bolt passing through the first component and the insert of the tolerance compensation fastening assembly and threadedly engages with the nut,
wherein the bolt engages with the insert and drives the insert to move relative to the receiver in the first rotational direction so that the flange of the insert abuts against the first component.
